(19) United States
(12) Patent Application Publication
(10) Pub. No.: US 2007/0170867 A1
(43) Pub. Date: Jul. 26, 2007

(54) Plasma Immersion Ion Source With Low Effective Antenna Voltage

(75) Inventors: Harold M. Persing, Westbrook, ME (US); Vikram Singh, North Andover, MA (US); Edmund J. Winder, Waltham, MA (US)

Correspondence Address: RAUSCHENBACH PATENT LAW GROUP, LLC, P.O. BOX 387, BEDFORD, MA, 01730, US

(73) Assignee: VARIAN SEMICONDUCTOR EQUIPMENT ASSOCIATES, INC., Gloucester, MA (US)

(21) Appl. No.: 11/617,785

(22) Filed: Dec. 29, 2006

Related U.S. Application Data
(60) Provisional application No. 60/761,518, filed on Jan. 24, 2006.

(51) Int. Cl. H01J 7/24; C23F 1/00

(52) U.S. Cl. 315/111.21; 156/345.48

(57) ABSTRACT

A plasma source includes a chamber that contains a process gas. The chamber includes a dielectric window that passes electromagnetic radiation. A RF power supply generates a RF signal. At least one RF antenna with a reduced effective antenna voltage is connected to the RF power supply. The at least one RF antenna is positioned proximate to the dielectric window so that the RF signal electromagnetically couples into the chamber to excite and ionize the process gas, thereby forming a plasma in the chamber.

### RELATED APPLICATION SECTION

This application claims priority to U.S. Provisional Patent Application Ser. No. 60/761,518, filed Jan. 24, 2006, entitled “System And Method For Lowering Effective Antenna Voltage In RF-Driven Plasma Immersion Implanter,” the entire application of which is incorporated herein by reference.

The section headings used herein are for organizational purposes only and should not to be construed as limiting the subject matter described in the present application.

### BACKGROUND OF THE INVENTION

Conventional beam-line ion implanters accelerate ions with an electric field. The accelerated ions are filtered according to their mass-to-charge ratio to select the desired ions for implantation. Recently plasma doping systems have been developed to meet the doping requirements of some modern electronic and optical devices. Plasma doping is sometimes referred to as PLAD or plasma immersion ion implantation (PIII). These plasma doping systems immerse the target in a plasma containing dopant ions and bias the target with a series of negative voltage pulses. The electric field within the plasma sheath accelerates ions toward the target which implants the ions into the target surface.

The plasma sources described herein are inductively coupled plasma sources. Inductively coupled plasma sources generate plasmas with electrical currents produced by electromagnetic induction. A time-varying electric current is passed through planar and/or cylindrical coils to generate a time varying magnetic field which induces electrical currents into a process gas thereby breaking down the process gas and forming a plasma. Inductively coupled plasma sources are well suited for plasma doping applications because the planar and/or cylindrical coils are positioned outside of the plasma chamber and, therefore, such sources are not subject to electrode contamination.

### BRIEF DESCRIPTION OF THE DRAWINGS

The aspects of this invention may be better understood by referring to the following description in conjunction with the accompanied drawings, in which like numerals indicate like structural elements and features in various figures. The drawings are not necessarily to scale. A skilled artisan will understand that the drawings, described below, are for illustration purposes only. The drawings are not intended to limit the scope of the present teachings in any way.

FIG. 1 illustrates one embodiment of a RF plasma source for a plasma doping apparatus according to the present invention.

FIG. 2 is a schematic diagram of a plasma source power system including a termination according to the present invention that reduces the energy of ions in the plasma and thus metal contamination caused by sputtering the dielectric window.

FIG. 3A illustrates a bottom view of one embodiment of the planar antenna coil of the RF plasma source according to the present invention.

FIG. 3B illustrates a cross sectional view a portion of a plasma source according to the present invention including a Faraday shield on only the planar antenna coil.

FIG. 3C illustrates a cross sectional view a portion of a plasma source according to the present invention that includes Faraday shields on both the planar and the helical antenna coils.

FIG. 4 illustrates a capacitance model of one embodiment of a RF plasma generator according to the present invention that includes a low dielectric constant material that forms a capacitive voltage divider which lowers the effective RF antenna voltage.

### DETAILED DESCRIPTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

For example, although the methods and apparatus of the present invention are described in connection with PLAD, a plasma source according to the present invention can be used for numerous other applications. Also, it is understood that a plasma source according to the present invention can include any one or all of the methods for reducing the effective antenna voltage and thus the undesirable sputtering of dielectric material.

It should be understood that the individual steps of the methods of the present invention may be performed in any order and/or simultaneously as long as the invention remains operable. Furthermore, it should be understood that the apparatus of the present invention can include any number or all of the described embodiments as long as the invention remains operable.

One problem with plasma immersion ion implantation is that metal contamination occurs when the dielectric window is sputtered with the constituent ions in the plasma. It is known in the art that aluminum contamination can result from sputtering of the Al₂O₃ dielectric material forming the PLAD RF plasma source. Sputtering occurs because there are relatively high voltages applied to the RF antenna that accelerate the ions in the plasma to a relatively high energy. These energetic ions strike the Al₂O₃ dielectric material and dislodge Al₂O₃ molecules that travel to the substrate or workpiece being ion implanted.

It is generally desirable to reduce aluminum and Al₂O₃ contamination in plasma immersion ion implantation processes to an areal density of less than 5×10¹¹/cm². However, many PLAD implantation processes using known plasma reactors, and using BF₃ and AsH₃, result in aluminum and Al₂O₃ areal densities that are significantly greater than 5×10¹¹/cm².

One aspect of the present invention relates to methods and apparatus for lowering the energy of ions in plasma immersion ion implantation tool in order to reduce the sputtering of the Al₂O₃ dielectric material in the PLAD plasma source. Methods and apparatus according to the present invention reduce the sputtering of the Al₂O₃ dielectric material in PLAD plasma sources by reducing the RF driving voltage applied to the RF coil.

A PLAD plasma source according to the present invention is designed to reduce metal contamination by including one or more features that reduce the voltage across the RF antenna. Reducing the voltage across the RF antenna according to the present invention will reduce the energy of ions in the plasma and the resulting undesirable sputtering of dielectric material while providing a plasma with the desired plasma density. It is understood that a plasma source according to the present invention can include any number or all of the features described herein to reduce the voltage across the RF antenna. It is further understood that a plasma source according to the present invention can be used for numerous plasma doping applications as well as numerous other application where it is desirable to generate plasmas with relatively low energy ions.

One feature of a plasma source according to the present invention that reduces the energy of ions in the plasma is that the RF antenna can be terminated with an impedance that reduces the voltage across the antenna. Plasma sources for prior art PLAD systems terminate the RF antenna to ground potential. Terminating the RF antenna with a capacitance can significantly reduce the maximum voltage generated on the antenna. For example, in some embodiments, the maximum voltage applied to the antenna can be reduced by a factor of two for a particular plasma density.

Another feature of a plasma source according to the present invention that reduces the energy of ions in the plasma is that the plasma source itself is specially designed to apply relatively low voltages across the RF antenna. That is, the plasma source is designed so that ions experience a reduced accelerating voltage. As described further herein the antenna is isolated from the Al₂O₃ dielectric window material by an additional dielectric layer that has a relatively low dielectric constant compared to the dielectric constant of the Al₂O₃ dielectric window material. The additional relatively low dielectric constant dielectric layer effectively forms a capacitive voltage divider that reduces the voltage across the RF antenna.

Yet another feature of a plasma source according to the present invention that reduces the energy of ions in the plasma is that the plasma source includes a Faraday shield. In one embodiment the Faraday shield is a spray-coated aluminum Faraday shield. The Faraday shield greatly reduces the RF voltage experienced by the ions in the plasma.

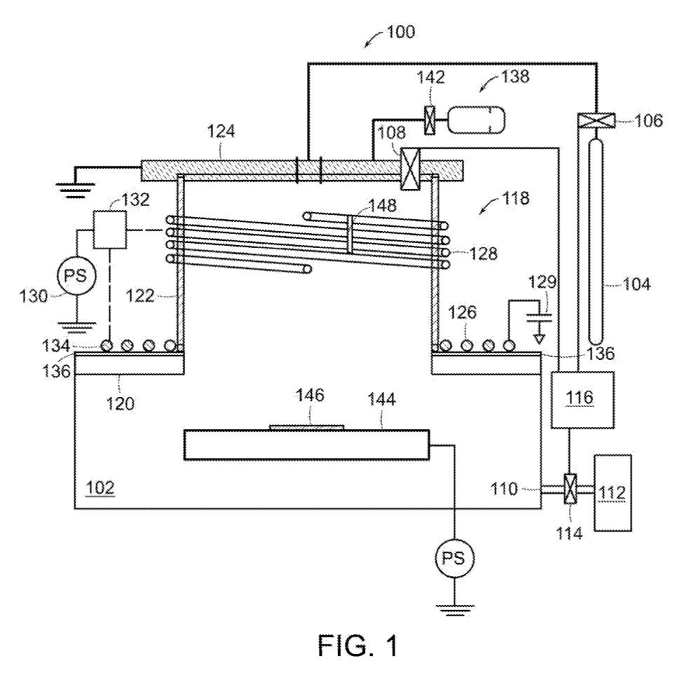

FIG. 1 illustrates one embodiment of a RF plasma source 100 according the present invention that is suitable for use with a plasma doping apparatus. The plasma source 100 is an inductively coupled plasma source that includes both a planar and a helical RF coil and a conductive top section. A similar RF inductively coupled plasma source is described in U.S. patent application Ser. No. 10/905,172, filed on Dec. 20, 2004, which is assigned to the present assignee. The entire specification of U.S. patent application Ser. No. 10/905,172 is incorporated herein by reference. The plasma source 100 is well suited for PLAD applications because it can provide a highly uniform ion flux and the source also efficiently dissipates heat generated by secondary electron emissions.

More specifically, the plasma source 100 includes a plasma chamber 102 that contains a process gas supplied by an external gas source 104. A process gas source 104, which is coupled to the chamber 102 through a proportional valve 106, supplies the process gas to the chamber 102. In some embodiments, a gas baffle is used to disperse the gas into the plasma source 102. A pressure gauge 108 measures the pressure inside the chamber 102. An exhaust port 110 in the chamber 102 is coupled to a vacuum pump 112 that evacuates the chamber 102. An exhaust valve 114 controls the exhaust conductance through the exhaust port 110.

A gas pressure controller 116 is electrically connected to the proportional valve 106, the pressure gauge 108, and the exhaust valve 114. The gas pressure controller 116 maintains the desired pressure in the plasma chamber 102 by controlling the exhaust conductance and the process gas flow rate in a feedback loop that is responsive to the pressure gauge 108. The exhaust conductance is controlled with the exhaust valve 114. The process gas flow rate is controlled with the proportional valve 106.

In some embodiments, a ratio control of trace gas species is provided to the process gas by a mass flow meter that is coupled in-line with the process gas that provides the primary dopant gas species. Also, in some embodiments, a separate gas injection means is used for in-situ conditioning species. Furthermore, in some embodiments, a multi-port gas injection means is used to provide gases that cause neutral chemistry effects that result in across wafer variations.

The chamber 102 has a chamber top 118 including a first section 120 formed of a dielectric material that extends in a generally horizontal direction. A second section 122 of the chamber top 118 is formed of a dielectric material that extends a height from the first section 120 in a generally vertical direction. The first and second sections 120, 122 are sometimes referred to herein generally as the dielectric window. It should be understood that there are numerous variations of the chamber top 118. For example, the first section 120 can be formed of a dielectric material that extends in a generally curved direction so that the first and second sections 120, 122 are not orthogonal as described in U.S. patent application Ser. No. 10/905,172, which is incorporated herein by reference. In other embodiment, the chamber top 118 includes only a planer surface.

The shape and dimensions of the first and the second sections 120, 122 can be selected to achieve a certain performance. For example, one skilled in the art will understand that the dimensions of the first and the second sections 120, 122 of the chamber top 118 can be chosen to improve the uniformity of the plasma. In one embodiment, a ratio of the height of the second section 122 in the vertical direction to the length across the second section 122 in the horizontal direction is adjusted to achieve a more uniform plasma. For example, in one particular embodiment, the ratio of the height of the second section 122 in the vertical direction to the length across the second section 122 in the horizontal direction is in the range of 1.5 to 5.5.

The dielectric materials in the first and second sections 120, 122 provide a medium for transferring the RF power from the RF antenna to a plasma inside the chamber 102. In one embodiment, the dielectric material used to form the first and second sections 120, 122 is a high purity ceramic material that is chemically resistant to the process gases and that has good thermal properties. For example, in some embodiments, the dielectric material is 99.6% Al₂O₃ or AlN. In other embodiments, the dielectric material is Yittria and YAG.

A lid 124 of the chamber top 118 is formed of a conductive material that extends a length across the second section 122 in the horizontal direction. In many embodiments, the conductivity of the material used to form the lid 124 is high enough to dissipate the heat load and to minimize charging effects that results from secondary electron emission. Typically, the conductive material used to form the lid 124 is chemically resistant to the process gases. In some embodiments, the conductive material is aluminum or silicon.

The lid 124 can be coupled to the second section 122 with a halogen resistant O-ring made of fluoro-carbon polymer, such as an O-ring formed of Chemrz and/or Kalrex materials. The lid 124 is typically mounted to the second section 122 in a manner that minimizes compression on the second section 122, but that provides enough compression to seal the lid 124 to the second section. In some operating modes, the lid 124 is RF and DC grounded as shown in FIG. 1.

Some plasma doping processes generate a considerable amount of non-uniformly distributed heat on the inner surfaces of the plasma source 100 because of secondary electron emissions. In some embodiments, the lid 124 comprises a cooling system that regulates the temperature of the lid 124 and surrounding area in order to dissipate the heat load generated during processing. The cooling system can be a fluid cooling system that includes cooling passages in the lid 124 that circulate a liquid coolant from a coolant source.

A RF antenna is positioned proximate to at least one of the first section 120 and the second section 122 of the chamber top 118. The plasma source 100 in FIG. 1 illustrates two separate RF antennas that are electrically isolated from one another. However, in other embodiments, the two separate RF antennas are electrically connected. In the embodiment shown in FIG. 1, a planar coil RF antenna 126 (sometimes called a planar antenna or a horizontal antenna) having a plurality of turns is positioned adjacent to the first section 120 of the chamber top 118. In addition, a helical coil RF antenna 128 (sometimes called a helical antenna or a vertical antenna) having a plurality of turns surrounds the second section 122 of the chamber top 118.

A RF source 130, such as a RF power supply, is electrically connected to at least one of the planar coil RF antenna 126 and helical coil RF antenna 128. In many embodiments, the RF source 130 is coupled to the RF antennas 126, 128 by an impedance matching network 132 that matches the output impedance of the RF source 130 to the impedance of the RF antennas 126, 128 in order to maximize the power transferred from the RF source 130 to the RF antennas 126, 128. Dashed lines from the output of the impedance matching network 132 to the planar coil RF antenna 126 and the helical coil RF antenna 128 are shown to indicate that electrical connections can be made from the output of the impedance matching network 132 to either or both of the planar coil RF antenna 126 and the helical coil RF antenna 128.

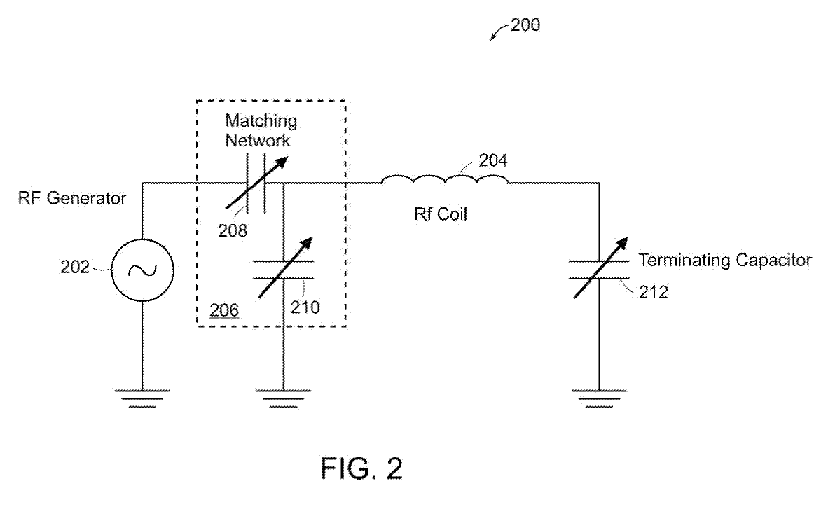

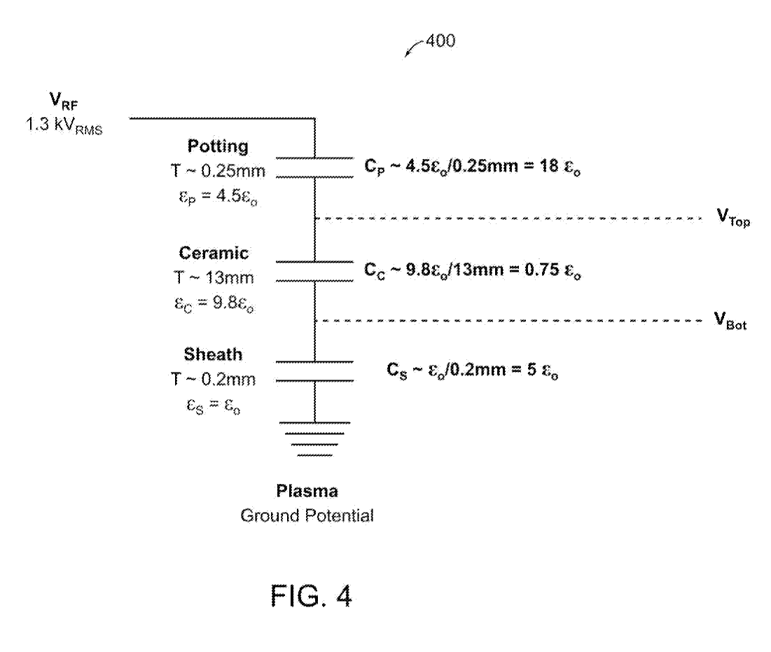

In one embodiment of the present invention, at least one of the planar coil RF antenna 126 and the helical coil RF antenna 128 is terminated with an impedance 129. In many embodiments, the impedance 129 is a capacitive reactance, such as a fixed or variable capacitor. As described in connection with FIGS. 2 and 4, terminating the RF antenna with a capacitor will reduce the effective coil voltage and the resulting metal contamination as described herein.

Also, in some embodiments, at least one of the planar coil RF antenna 126 and the helical coil RF antenna 128 includes a dielectric layer 134 that has a relatively low dielectric constant compared to the dielectric constant of the Al₂O₃ dielectric window material. The dielectric layer 134 can be a potting material as described herein. The relatively low dielectric constant dielectric layer 134 effectively forms a capacitive voltage divider that reduces the voltage across the RF antennas 126, 128.

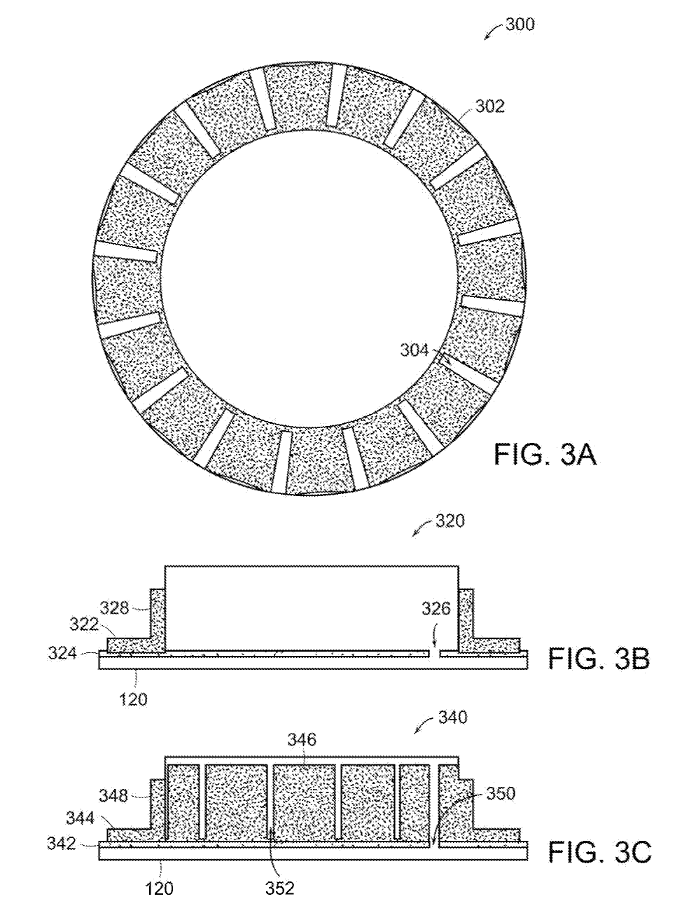

In addition, in some embodiments, at least one of the planar coil RF antenna 126 and the helical coil RF antenna 128 includes a Faraday shield 136 as described in connection with FIGS. 3A, 3B, and 3C. The Faraday shield 136 also reduces the voltage across the RF antennas 126, 128 as described herein.

In some embodiments, at least one of the planar coil RF antenna 126 and the helical coil RF antenna 128 is formed such that it can be liquid cooled. Cooling at least one of the planar coil RF antenna 126 and the helical coil RF antenna 128 will reduce temperature gradients caused by the RF power propagating in the RF antennas 126, 128.

In some embodiments, the plasma source 100 includes a plasma igniter 138. Numerous types of plasma igniters can be used with the plasma source apparatus of the present invention. In one embodiment, the plasma igniter 138 includes a reservoir 140 of strike gas, which is a highly-ionizable gas, such as argon (Ar), which assists in igniting the plasma. The reservoir 140 is coupled to the plasma chamber 102 with a high conductance gas connection. A burst valve 142 isolates the reservoir 140 from the process chamber 102. In another embodiment, a strike gas source is plumbed directly to the burst valve 142 using a low conductance gas connection. In some embodiments, a portion of the reservoir 140 is separated by a limited conductance orifice or metering valve that provides a steady flow rate of strike gas after the initial high-flow-rate burst.

A platen 144 is positioned in the process chamber 102 a height below the top section 118 of the plasma source 102. The platen 144 holds a wafer 146, such as a substrate or wafer, for ion implantation. In many embodiments, the wafer 146 is electrically connected to the platen 144. In the embodiment shown in FIG. 1, the platen 144 is parallel to the plasma source 102. However, in one embodiment of the present invention, the platen 144 is tilted with respect to the plasma source 102.

A platen 144 is used to support a wafer 146 or other workpieces for processing. In some embodiments, the platen 144 is mechanically coupled to a movable stage that translates, scans, or oscillates the wafer 146 in at least one direction. In one embodiment, the movable stage is a dither generator or an oscillator that dithers or oscillates the wafer 146. The translation, dithering, and/or oscillation motions can reduce or eliminate shadowing effects and can improve the uniformity of the ion beam flux impacting the surface of the wafer 146.

In some embodiments, a deflection grid is positioned in the chamber 102 proximate to the platen 144. The deflection grid is a structure that forms a barrier to the plasma generated in the plasma source 102 and that also defines passages through which the ions in the plasma pass through when the grid is properly biased.

One skilled in the art will appreciate that the there are many different possible variations of the plasma source 100 that can be used with the features of the present invention. See for example, the descriptions of the plasma sources in U.S. patent application Ser. No. 10/908,009, filed Apr. 25, 2005, entitled “Tilted Plasma Doping.” Also see the descriptions of the plasma sources in U.S. patent application Ser. No. 11/163,303, filed Oct. 13, 2005, entitled “Conformal Doping Apparatus and Method.” Also see the descriptions of the plasma sources in U.S. patent application Ser. No. 11/163,307, filed Oct. 13, 2005, entitled “Conformal Doping Apparatus and Method.” In addition, see the descriptions of the plasma sources in U.S. patent application Ser. No. 11/566,418, filed Dec. 4, 2006, entitled “Plasma Doping with Electronically Controllable Implant Angle.” The entire specification of U.S. patent application Ser. Nos. 10/908,009, 11/163,303, 11/163,307 and 11/566,418 are herein incorporated by reference.

In operation, the RF source 130 generates RF currents that propagate in at least one of the RF antennas 126 and 128. That is, at least one of the planar coil RF antenna 126 and the helical coil RF antenna 128 is an active antenna. The term “active antenna” is herein defined as an antenna that is driven directly by a power supply. The RF currents in the RF antennas 126, 128 then induce RF currents into the chamber 102. The RF currents in the chamber 102 excite and ionize the process gas so as to generate a plasma in the chamber 102. The plasma sources 100 can operate in either a continuous mode or a pulsed mode.

In some embodiments, one of the planar coil antenna 126 and the helical coil antenna 128 is a parasitic antenna. The term “parasitic antenna” is defined herein to mean an antenna that is in electromagnetic communication with an active antenna, but that is not directly connected to a power supply. In other words, a parasitic antenna is not directly excited by a power supply, but rather is excited by an active antenna. In some embodiments of the invention, one end of the parasitic antenna is electrically connected to ground potential in order to provide antenna tuning capabilities. In this embodiment, the parasitic antenna includes a coil adjuster 148 that is used to change the effective number of turns in the parasitic antenna coil. Numerous different types of coil adjusters, such as a metal short, can be used.

FIG. 2 is a schematic diagram of a plasma source power system 200 including a termination according to the present invention that reduces the energy of ions in the plasma and thus metal contamination caused by sputtering the dielectric window. The power system 200 includes a RF power supply 202 that generates a RF signal for transmission in an RF antenna coil 204.

A matching network 206 is electrically connected to the output of the RF power supply 202. The schematic diagram of the power system 200 shows a variable reactance matching network 206 that includes a series connected variable capacitor 208 and a parallel connected variable capacitor 210 terminated to ground potential. One skilled in the art will appreciate that there are many variations of the matching network 206 that are within the scope of the present invention. Numerous suitable matching networks are commercially available.

The output of the matching network 206 is electrically connected to the input of the RF antenna coil 204. The output of the RF antenna coil 204 is terminated with a variable reactance that is shown as a variable capacitor 212. However, it is understood that in some embodiments, the antenna termination has a fixed capacitive reactance. The variable capacitor 212 must be able to withstand relatively high voltages and currents for many applications. The matching network 206 is designed to match the output impedance of the RF power supply 202 to the impedance seen by the RF power supply 202. In the embodiment shown, the impedance seen by the RF power supply 202 is the combination of the impedance of the RF antenna coil 204 and the capacitive reactance of the variable capacitance 212 terminating the RF antenna coil 204.

The matching network 206 is manually operated in some embodiments. In these embodiments, the operator manually adjusts the variable capacitors 208, 210 in the matching network 206 to obtain an approximate impedance match. In other embodiments, the matching network 206 is automatically operated to obtain the approximate impedance match. Typically, the desired impedance match results in a maximum transfer of power available from the RF power supply 202 to the load connected to the output of the RF power supply 202, which in the power transfer system 200 of FIG. 2, is the series combination of the RF antenna coil 204 and the variable capacitor 212.

The presence of the variable capacitor 212 antenna termination makes it more difficult to obtain a good impedance match. Prior art inductive coil antennas used for plasma generation typically are terminated directly to ground. Such prior art inductive coils are relatively easy to match to the RF source and are also relatively efficient. However, the combination of the variable capacitor 212 antenna termination and the matching network 206 can be used to match a wide range of antenna coils and antenna terminations to the RF power supply 202.

The presence of the variable capacitor 212 antenna termination reduces the effective antenna coil voltage compared with prior art power transfer systems while delivering sufficient power to the plasma. The term “effective antenna coil voltage” is defined herein to mean the voltage drop across the RF antenna coil 204. In other words, the effective coil antenna voltage is the voltage “seen by the ions” or equivalently the voltage experienced by the ions in the plasma.

Thus, the relatively low effective antenna voltage results in the generation of a plasma having relatively low energy ions. These low energy ions result in reduced sputtering of dielectric material. Therefore, the lower effective antenna voltage used in the power transfer system of the present invention results in reduced metal contamination caused by sputtering the dielectric window.

Terminating the RF antenna coil 204 as shown in FIG. 2 can reduce the effective antenna voltage by approximately 40% or more depending on the design. Terminating the RF antenna coil as shown in FIG. 2 has been shown to reduce aluminum areal density caused by sputtering the dielectric window to acceptable levels during PLAD implants using BF3 and AsH3. Modeling and experimentation has shown that the voltage on the antenna reaches a minimum (V_{MAX}/2) when the termination capacitance is approximately 1,600 pF.

FIG. 3A illustrates a bottom view of one embodiment of the planar antenna coil 300 of the RF plasma source according to the present invention. The planar antenna coil 300 includes two features that reduce the effective antenna voltage. Referring to both FIGS. 1 and 3A, one feature shown in the bottom view of FIG. 3A is that, in some embodiments, at least one of the planar and the helical coil antennas 126, 128 includes a relatively low dielectric constant material that is positioned between the planar and the helical coil antennas 126, 128 and the dielectric windows 120, 122.

In some embodiments, the relatively low dielectric constant material is a potting material. Potting material is a dielectric material that is typically resistant to moisture. Potting material is typically a liquid or a putty-like substance. Potting material is frequently used as a protective coating on sensitive areas of electrical and electronic equipment. In one embodiment of the present invention, the potting material is a thermally conducting elastomer that also insulates the planar RF coil 300.

As described further in connection with FIG. 4, the relatively low dielectric constant material creates a capacitive voltage divider. This capacitive voltage divider significantly reduces the effective antenna voltage and thus, the voltage that accelerates the ions in the plasma. Therefore, the relatively low dielectric material reduces the metal contamination caused by sputtering the dielectric windows 120, 122.

Another feature in the bottom view of the planar coil antenna 300 shown in FIG. 3A is that, in some embodiments, a Faraday shield 302 is constructed on the bottom surface of the antenna coil. A Faraday shield (also called a Faraday cage) is an enclosure formed by a conducting material or a mesh of conducting material that blocks out external static electrical fields. Externally applied electric fields will cause the charges on the outside of the conducing material to rearrange so as to completely cancel the electric fields effects in inside of the Faraday shield 302.

There are many possible ways to form a Faraday shield 302 on the bottom surface of the planar antenna coil 300. For example, in one embodiment of the present invention, a mask defining the Faraday shield 302 geometry is formed on the surface of the dielectric window 120. Aluminum can be spray coated on the surface defined by the mask. A spray coating approximately 500 μm thick is sufficient for many applications.

The pattern of the Faraday shield 302 geometry is chosen so that the dielectric window 120 is sufficiently shielded to prevent significant sputtering of the dielectric window material. In addition, the pattern of the Faraday shield 302 geometry is chosen so that enough area of the dielectric window 120 is exposed (i.e. unshielded) to allow for sufficient radiation to pass through the dielectric window 120 and into the plasma chamber 102 to form and sustain the desired plasma. The pattern shown in FIG. 3A includes periodically spaced gaps 304 in the Faraday shield 302 that allow for sufficient radiation to pass through the dielectric window 120 and into the plasma chamber 102 to form and sustain the desired plasma.

In some designs according to the present invention, the Faraday shield 302 is electrically “floating” during plasma ignition and electrically grounded during the ion implant.

The planar antenna coil 300 is then affixed to the metalized dielectric window 120. In some embodiments, the planar antenna coil 300 is affixed to the metalized dielectric window 120 using potting material or other insulating material that has a relatively low dielectric constant compared with the dielectric constant of the dielectric window 120. The thickness of the potting material or other insulating material must be thick enough to sufficiently insulate the planar antenna coil 300 from the metal shield. For example, in some embodiments, the planar antenna coil 300 is affixed to the metalized dielectric window 122 using a thermally conducting elastomer.

FIG. 3B illustrates a cross sectional view a portion of a plasma source 320 according to the present invention including a planar antenna coil 322 with a Faraday shield 324. In this embodiment, the planar antenna coil 322 is potted with a relatively low dielectric constant material in order to insulate the planar antenna coil and to reduce the effective coil voltage as described herein. The gap 326 in the Faraday shield 324 allows for sufficient radiation to pass through the dielectric window 120 and into the plasma chamber 102. In this embodiment, the helical antenna 122 does not include a Faraday shield.

FIG. 3C illustrates a cross sectional view a portion of a plasma source 340 according to the present invention that includes a first Faraday shield 342 on a planar antenna coil 344 and a second Faraday shield 346 on a helical antenna coil 348. In this embodiment, both the planar antenna 344 and the helical antenna 348 are potted with a relatively low dielectric material to insulate the antenna coils 344, 348 and to reduce the effective coil voltage as described herein. A gap 350 (FIG. 3A) in the Faraday shield on the planar antenna 344 allows for sufficient radiation to pass through the dielectric window 120 and into the plasma chamber 102. A gap 352 in the Faraday shield 346 on the helical antenna 348 allows for sufficient radiation to pass through the dielectric window 122 and into the plasma chamber 102.

It is understood that the methods and apparatus of the present invention can include one or both of these features that reduce the effective antenna voltage. That is, the methods and apparatus of the present invention can include one or both of the relatively low dielectric constant material (which creates a capacitive voltage divider) and at least one Faraday shield 342, 346. It is further understood that these features (the addition of the relatively low dielectric constant material and the at least one Faraday shield) can be employed on either or both of the planar and the helical antenna coil. One skilled in the art will appreciate that there are many permutations of using capacitive voltage dividers and Faraday shields according to the teachings of the present invention.

FIG. 4 illustrates a capacitance model 400 of one embodiment of a RF plasma generator according to the present invention that includes a low dielectric constant material that forms a capacitive voltage divider which lowers the effective RF antenna voltage. The lower effective RF antenna voltage reduces the energy of ions in the plasma and thus reduces metal contamination caused by sputtering the dielectric window.

The capacitance model 400 shows the output of the RF power supply 130 (FIG. 1) being connected to three series connected capacitors that represent separate capacitive reactance components in the plasma generating system. It is well known that capacitance is proportional to the surface area of the conducting plate and to the permittivity of the dielectric material that separates the plates forming the capacitor. In addition, capacitance is inversely proportional to the distance between the plates forming the capacitor. The distance between the plates is indicated as T in FIG. 4.

The capacitance C_{P} represents the potting material capacitance that is described in connection with FIG. 3. The dielectric constant for thermally conducting elastomer potting material is 4.5ε₀ in the example presented in FIG. 4. The distance between plates of the potting material capacitor is 0.25 mm in the example presented in FIG. 4. The resulting ratio of the capacitance to the area of the capacitor plates is 18ε₀ for the example shown in FIG. 4.

The capacitance C_{C} represents the capacitance of the Al₂O₃ ceramic dielectric material forming the dielectric windows 120, 122. The dielectric constant of the Al₂O₃ material is equal to 9.8ε₀ in the example shown in FIG. 4. This dielectric constant corresponds to the dielectric constant for 95% or greater content of aluminum oxide. The distance between plates of the ceramic capacitor is 13 mm in the example shown in FIG. 4.

The capacitance C_{S} represents the capacitance of the plasma sheath. A plasma sheath is a transition layer from the plasma to a solid surface. In particular, the plasma sheath is a layer in the plasma that has an excess positive charge that balances an opposite negative charge on the surface of the material contacting the plasma. The thickness of such a layer is several Debye lengths thick. The Debye length is a function of certain plasma characteristics, such as the plasma density and the plasma temperature. The dielectric constant of the plasma sheath is the dielectric constant of air, which is commonly referred to as ε₀. The distance between plates of the plasma sheath is 0.2 mm in the example presented in FIG. 4.

In many embodiments, the capacitance of the plasma sheath is greater than the capacitance of the dielectric windows 120, 122 and the capacitance of the dielectric windows 120, 122 is greater than the capacitance of the potting material. Therefore, the voltage at the top of the dielectric windows 120, 122 is obtained by the following well known equation:

$${V}_{Top} = {V}_{RF} \frac{{C}_{P}}{{C}_{P} + {C}_{C}} \approx 0.96 {V}_{RF} ,$$

which indicates that a 0.04V_{RF} volt drop occurs across the potting material. The voltage at the bottom of the dielectric windows 120, 122 where the plasma contacts the dielectric windows 120, 122, is obtained by the well known equation:

$${V}_{Bot} = {V}_{RF} \frac{{C}_{P}}{{C}_{P} + {C}_{C}} \frac{{C}_{C}}{{C}_{C} + {C}_{S}} \approx 0.125 {V}_{RF} .$$

Thus, the presence of the potting material between the RF antenna coil and the dielectric windows 120, 122 that form the potting capacitor, which has a lower dielectric constant than the dielectric constant of the dielectric windows 120, 122, creates a capacitive voltage divider. This capacitive voltage divider significantly reduces the effective antenna voltage and thus, the voltage that accelerates the ions in the plasma.

### Equivalents

While the present teachings are described in conjunction with various embodiments and examples, it is not intended that the present teachings be limited to such embodiments. On the contrary, the present teachings encompass various alternatives, modifications and equivalents, as will be appreciated by those of skill in the art, may be made therein without departing from the spirit and scope of the invention as defined by the appended claims.

What is claimed is:

1. A plasma source comprising:
a) a chamber that contains a process gas, the chamber comprising a dielectric window that passes electromagnetic radiation;
b) a RF power supply that generates a RF signal at an output; and
c) at least one RF antenna having an input that is electrically connected to the output of the RF power supply and an output that is terminated with an impedance that reduces an effective RF antenna voltage, the at least one RF antenna being positioned proximate to the dielectric window so that the RF signal electromagnetically couples into the chamber to excite and ionize the process gas, thereby forming a plasma in the chamber.

2. The plasma source of claim 1 wherein the impedance that reduces the effective RF antenna voltage comprises a capacitive reactance.

3. The plasma source of claim 2 wherein the capacitive reactance comprises a capacitor having a variable capacitance.

4. The plasma source of claim 1 wherein the at least one RF antenna comprises one of a planar coil RF antenna and a helical coil RF antenna.

5. The plasma source of claim 1 wherein the at least one RF antenna comprises both a planar coil RF antenna and a helical coil RF antenna.

6. The plasma source of claim 5 wherein the planer coil RF antenna and the helical coil RF antenna are electrically connected.

7. The plasma source of claim 5 wherein the planer coil RF antenna and the helical coil RF antenna are electromagnetically coupled.

8. The plasma source of claim 1 further comprising a dielectric material positioned between the at least one RF antenna and the dielectric window so as to form a capacitive voltage divider that further reduces the effective RF antenna voltage.

9. The plasma source of claim 1 further comprising a Faraday shield surrounding at least a portion of the at least one RF antenna.

10. The plasma source of claim 9 wherein the Faraday shield comprises a conductive coating deposited over a dielectric material on the at least one RF antenna.

11. The plasma source of claim 1 wherein the Faraday shield is electrically floating during plasma ignition and is coupled to ground potential after plasma ignition.

12. A plasma source comprising:
a) a chamber that contains a process gas, the chamber comprising a dielectric window that passes electromagnetic radiation;
b) a RF power supply that generates a RF signal at an output;
c) at least one RF antenna having an input that is electrically connected to the output of the RF power supply, the at least one RF antenna being positioned proximate to the dielectric window so that the RF signal electromagnetically couples into the chamber to excite and ionize the process gas, thereby forming a plasma in the chamber; and
d) a dielectric material positioned between the at least one RF antenna and the dielectric window so as to form a capacitive voltage divider that reduces an effective RF antenna voltage.

13. The plasma source of claim 12 wherein the at least one RF antenna comprises one of a planar coil RF antenna and a helical coil RF antenna.

14. The plasma source of claim 12 wherein the at least one RF antenna comprises both a planar coil RF antenna and a helical coil RF antenna.

15. The plasma source of claim 14 wherein the planer coil RF antenna and the helical coil RF antenna are electrically connected.

16. The plasma source of claim 14 wherein the planer coil RF antenna and the helical coil RF antenna are electromagnetically coupled.

17. The plasma source of claim 12 wherein the dielectric material positioned between the at least one RF antenna and the dielectric window comprises potting material that is deposited on an outer surface of the at least one RF antenna.

18. The plasma source of claim 17 wherein the potting material comprises a thermally conducting elastomer.

19. The plasma source of claim 12 wherein an output of the at least one RF antenna is terminated with an impedance that further reduces the effective RF antenna voltage.

20. The plasma source of claim 19 wherein the impedance that further reduces the effective RF antenna voltage comprises a capacitive reactance.

21. The plasma source of claim 12 further comprising a Faraday shield that is positioned between at least a portion of the at least one RF antenna and the dielectric window.

22. The plasma source of claim 21 wherein the Faraday shield comprises a conductive coating deposited over the dielectric material forming the capacitive voltage divider, the conductive material defining at least one gap for transmitting the RF signal.

23. The plasma source of claim 21 wherein the Faraday shield is electrically floating during plasma ignition and coupled to ground potential after plasma ignition.

24. A plasma source comprising:
a) a chamber that contains a process gas, the chamber comprising a dielectric window that passes electromagnetic radiation;
b) a RF power supply that generates a RF signal at an output;
c) at least one RF antenna having an input that is electrically connected to the output of the RF power supply, the at least one RF antenna being positioned proximate to the dielectric window so that the RF signal electromagnetically couples into the chamber to excite and ionize the process gas, thereby forming a plasma in the chamber; and
d) a Faraday shield positioned between at least a portion of the RF antenna and the dielectric window, the Faraday shield reducing an effective RF antenna voltage.

25. The plasma source of claim 24 wherein the at least one RF antenna comprises one of a planar coil RF antenna and a helical RF antenna.

26. The plasma source of claim 24 wherein the at least one RF antenna comprises both a planar coil RF antenna and a helical coil RF antenna.

27. The plasma source of claim 26 wherein the planer coil RF antenna and the helical coil RF antenna are electrically connected.

28. The plasma source of claim 26 wherein the planer coil RF antenna and the helical coil RF antenna are electromagnetically coupled.

29. The plasma source of claim 24 wherein the Faraday shield comprises a conductive coating that defines at least one gap for transmitting the RF signal.

30. The plasma source of claim 24 wherein the Faraday shield is electrically floating during plasma ignition and coupled to ground potential after plasma ignition.

31. The plasma source of claim 24 further comprising a dielectric material positioned between the at least one RF antenna and the Faraday shield so as to form a capacitive voltage divider that reduces the effective RF antenna voltage.

32. A method of generating a plasma, the method comprising:
a) containing a process gas in a chamber;
b) generating a RF signal;
c) reducing an effective antenna voltage of at least one RF antenna;
d) propagating the RF signal through the at least one RF antenna with the reduced effective antenna voltage; and
e) coupling the RF signal from the at least one RF antenna through a dielectric window to excite and ionize the process gas, thereby forming a plasma in the chamber.

33. The method of claim 32 wherein the reducing the effective antenna voltage comprises coupling the RF signal through a capacitive voltage divider.

34. The method of claim 32 wherein the reducing the effective antenna voltage comprises partially shielding the RF signal from the dielectric window.

35. The method of claim 32 wherein the reducing the effective antenna voltage comprises terminating the RF antenna with a capacitive reactance.
